(19) United States
(12) Patent Application Publication
(10) Pub. No.: US 2026/0107059 A1
(43) Pub. Date: Apr. 16, 2026

(54) IMAGING SYSTEM, IMAGING DEVICE, AND WEARABLE DEVICE

(71) Applicant: CANON KABUSHIKI KAISHA, Tokyo (JP)

(72) Inventor: TAKUMI TSUCHIYA, Kanagawa (JP)

(21) Appl. No.: 19/327,451

(22) Filed: Sep. 12, 2025

(30) Foreign Application Priority Data
Oct. 16, 2024 (JP) 2024-181286

(51) Int. Cl. H04N 23/60; G06F 1/16; G06F 3/01; H04N 23/66

(52) U.S. Cl. CPC H04N 23/64; G06F 1/163; G06F 3/016; H04N 23/66

(57) ABSTRACT

An imaging system according to the present disclosure includes an imaging device and a wearable device, wherein the imaging device or the wearable device is configured to perform a first determination process of determining a guidance position that is a position within an imaging range of the imaging device, wherein the imaging device or the wearable device is configured to perform a second determination process of determining a guidance direction that is a direction from the wearable device to the guidance position, and wherein the imaging device or the wearable device is configured to perform a control process of performing control such that a user wearing the wearable device is notified of the guidance direction by vibration of the wearable device.

### BACKGROUND

### Field of the Technology

The present disclosure relates to an imaging system, an imaging device, and a wearable device, and particularly, to a technology for linking the imaging device and the wearable device.

### Description of the Related Art

As wearable devices, there are wearable devices capable of giving haptics presentation. By giving haptics presentation, various types of information can be presented to the bodies of users coming in contact with the wearable devices. As haptics presentation, for example, tactile presentation or thermal presentation that presents force or motion by vibration, pressure, or the like is given.

Japanese Patent Laid-Open No. 2003-163822 discloses a technique in which a receiver receives radio waves from a transmitter of a camera and notifies a user of the receiver that an image is captured by the camera by vibration, a sound, an image, or the like.

However, in the technology of the related art disclosed in Japanese Patent Laid-Open No. 2003-163822, a user is merely notified that the image is captured by the camera. Therefore, even if the technology of the related art disclosed in Japanese Patent Laid-Open No. 2003-163822 is used, an imaging target user cannot immediately enter an imaging range of a camera when the user is outside of the imaging range of the camera (imaging device) and does not know a position of the camera.

### SUMMARY

The present disclosure provides a technology for enabling an imaging target user to immediately enter an imaging range of an imaging device.

The present disclosure its first aspect provides an imaging system including an imaging device and a wearable device, wherein the imaging device or the wearable device is configured to perform a first determination process of determining a guidance position that is a position within an imaging range of the imaging device, wherein the imaging device or the wearable device is configured to perform a second determination process of determining a guidance direction that is a direction from the wearable device to the guidance position, and wherein the imaging device or the wearable device is configured to perform a control process of performing control such that a user wearing the wearable device is notified of the guidance direction by vibration of the wearable device.

The present disclosure its second aspect provides an imaging device in an imaging system including the imaging device and a wearable device, wherein the imaging device or the wearable device is configured to perform a first determination process of determining a guidance position that is a position within an imaging range of the imaging device, wherein the imaging device or the wearable device is configured to perform a second determination process of determining a guidance direction that is a direction from the wearable device to the guidance position, and wherein the imaging device is configured to perform a control process of performing control such that a user wearing the wearable device is notified of the guidance direction by vibration of the wearable device.

The present disclosure its third aspect provides a wearable device in an imaging system including an imaging device and the wearable device, wherein the imaging device or the wearable device is configured to perform a first determination process of determining a guidance position that is a position within an imaging range of the imaging device, wherein the imaging device or the wearable device is configured to perform a second determination process of determining a guidance direction that is a direction from the wearable device to the guidance position, and wherein the wearable device is configured to perform a notification process of notifying the guidance direction to a user wearing the wearable device by vibration of the wearable device.

The present disclosure its fourth aspect provides a control method of an imaging system including an imaging device and a wearable device, the control method including determining a guidance position that is a position within an imaging range of the imaging device, determining a guidance direction that is a direction from the wearable device to the guidance position, and performing control such that a user wearing the wearable device is notified of the guidance direction by vibration of the wearable device.

The present disclosure its fifth aspect provides a non-transitory computer readable medium that stores a program, wherein the program causes a computer to execute a control method of an imaging system including an imaging device and a wearable device, the control method including determining a guidance position that is a position within an imaging range of the imaging device, determining a guidance direction that is a direction from the wearable device to the guidance position, and performing control such that a user wearing the wearable device is notified of the guidance direction by vibration of the wearable device.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration example of an imaging system according to a first embodiment.

FIGS. 2A and 2B are external views of the imaging device according to the first embodiment.

FIG. 3 is a flowchart illustrating an operation example of the imaging system according to the first embodiment.

FIG. 4 is a schematic diagram illustrating an operation example of the imaging system according to the first embodiment.

FIG. 5 is a schematic diagram illustrating an operation example of a wearable device according to the first embodiment.

FIG. 6 is a schematic diagram illustrating an operation example of the imaging system according to the first embodiment.

FIG. 7 is a schematic diagram illustrating a display example of an item according to the first embodiment.

FIG. 8 is a flowchart illustrating an operation example of an imaging system according to a second embodiment.

FIG. 9 is a schematic diagram illustrating an operation example of the imaging system according to the second embodiment.

FIG. 10 is a flowchart illustrating an operation example of an imaging system according to a third embodiment.

FIG. 11 is a schematic diagram illustrating an operation example of the imaging system according to the third embodiment.

### DESCRIPTION OF THE EMBODIMENTS

### First Embodiment

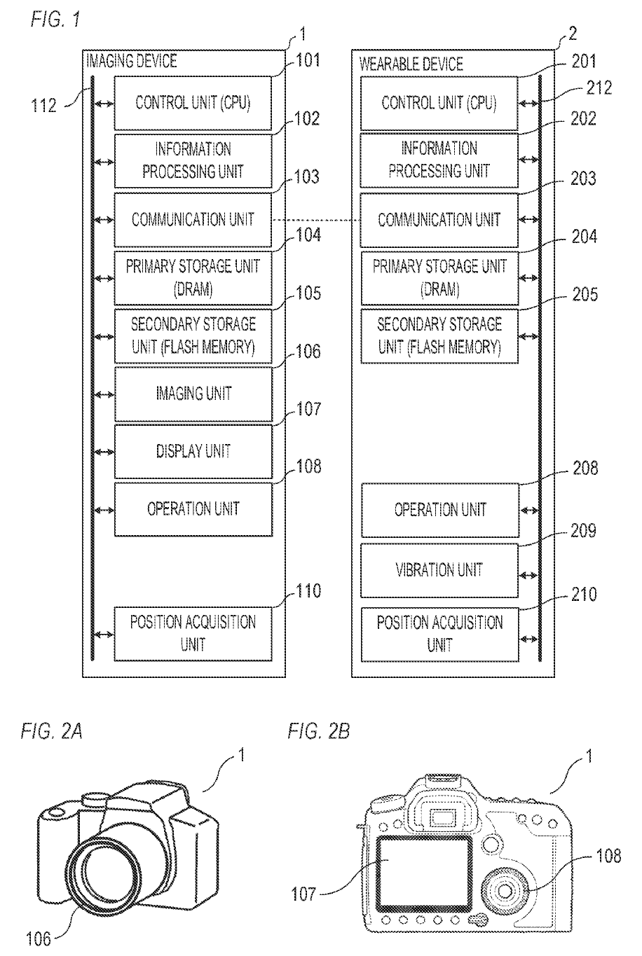

A first embodiment of the present disclosure will be described. FIG. 1 is a block diagram illustrating a configuration example of an imaging system according to a first embodiment. The imaging system in FIG. 1 includes an imaging device 1 and a wearable device 2. FIGS. 2A and 2B are external views of the imaging device 1. FIG. 2A is a front view (front perspective view) of the imaging device 1, and FIG. 2B is a rear view of the imaging device 1.

The imaging device 1 includes a control unit 101, an information processing unit 102, a communication unit 103, a primary storage unit 104, a secondary storage unit 105, an imaging unit 106, a display unit 107, an operation unit 108, and a position acquisition unit 110. These constituents are connected to a bus 112, and data is transmitted and received between the constituents via the bus 112.

The control unit 101 is, for example, a CPU and controls each unit (the information processing unit 102, the communication unit 103, the primary storage unit 104, the secondary storage unit 105, the imaging unit 106, the display unit 107, the operation unit 108, the position acquisition unit 110, and the like) of the imaging device 1.

The information processing unit 102 is a processing circuit (arithmetic unit) that performs various types of information processing (arithmetic processing). For example, the information processing unit 102 performs arithmetic processing of image data obtained by the imaging unit 106 (arithmetic processing for obtaining various evaluation values of the image data, and the like). The information processing unit 102 also performs arithmetic processing of data obtained by the communication unit 103, arithmetic processing of position data obtained by the position acquisition unit 110, and the like.

The communication unit 103 is a communication interface that communicates with an external device.

The primary storage unit 104 is, for example, a DRAM and temporarily stores data used by the control unit 101 and the information processing unit 102.

The secondary storage unit 105 is, for example, a flash memory and stores data used by the control unit 101 and the information processing unit 102, a processing result (for example, an encoded recorded image) of the information processing unit 102, and the like.

The imaging unit 106 includes, for example, an optical lens, an imaging element (image sensor), and an A/D converter and converts light from the outside (object) into digital data (image data).

The display unit 107 is a display that displays various images. The display unit 107 may have a touch panel that receives a touch operation with a user's finger, a stylus, or the like.

The operation unit 108 includes an operation member that receives a user operation and includes, for example, a button and a dial. The above-described touch panel is also an example of the operation member. When a user operation is performed on the operation members, the control unit 101 performs control in response to the user operation. The communication unit 103 may acquire a signal in response to a user operation on the external device, and the control unit 101 may perform control in accordance with a signal.

The position acquisition unit 110 includes, for example, a receiver of a global positioning system (GPS) and acquires a current position (position data) of the imaging device 1.

In the first embodiment, the imaging device 1 is a camera (digital camera), but the imaging device 1 may be a smartphone, a tablet terminal, or the like. The imaging device 1 may be an automatic imaging camera. The imaging device 1 may be able to rotate at an angle of view around at least one of a pan axis, a tilt axis, and a roll axis in addition to zooming and driving (changing) an iris. The rotation of an angle of view around the pan axis and the tilt axis can be implemented by adjusting an angle of the entire optical system including the optical lens and the imaging element. The rotation of an angle of view around the roll axis can be implemented by adjusting an angle of the imaging element. The imaging device 1 may be driven (moved) in at least any one of up and down directions, left and right directions, and front and rear directions. The imaging device 1 itself may be able to move or rotate like a drone. External equipment such as a movable platform such as a gimbal may be mounted to be detachable from the imaging device 1.

The wearable device 2 includes a control unit 201, an information processing unit 202, a communication unit 203, a primary storage unit 204, a secondary storage unit 205, an operation unit 208, a vibration unit 209, and a position acquisition unit 210. The constituents are connected to a bus 212, and data is transmitted and received between the constituents via the bus 212.

The control unit 201 is, for example, a CPU and controls each unit (the information processing unit 202, the communication unit 203, the primary storage unit 204, the secondary storage unit 205, the operation unit 208, the vibration unit 209, the position acquisition unit 210, and the like) of the wearable device 2.

The information processing unit 202 is a processing circuit (arithmetic unit) that performs various types of information processing (arithmetic processing). For example, the information processing unit 202 performs arithmetic processing of data obtained by the communication unit 203, arithmetic processing of position data obtained by the position acquisition unit 210, and the like.

The communication unit 203 is a communication interface that communicates with an external device.

The primary storage unit 204 is, for example, a DRAM, and temporarily stores data used by the control unit 201 and the information processing unit 202.

The secondary storage unit 205 is, for example, a flash memory and stores data used by the control unit 201 and the information processing unit 202, a processing result of the information processing unit 202, and the like.

The operation unit 208 includes an operation member that receives a user operation and includes, for example, a button and a dial. When a user operation is performed on the operation members, the control unit 201 performs control in response to the user operation. The communication unit 203 may acquire a signal in response to a user operation on the external device, and the control unit 201 may perform control in accordance with a signal.

The vibration unit 209 vibrates the wearable device 2. For example, the vibration unit 209 can notify the user wearing the wearable device 2 of a direction by vibrating a part of the wearable device 2, and can change the direction of the notification to the user by changing the portion to be vibrated.

The position acquisition unit 210 includes, for example, a receiver of a GPS and acquires a current position (position data) of the wearable device 2.

In the first embodiment, the wearable device 2 is a necklace-type device, but the wearable device 2 may be another device that comes into contact with a user's skin in a certain wide range. For example, the wearable device 2 may be a glove type device, a wristband type device, a belt type device, or the like. The wearable device 2 may be a smartwatch, a smartphone, a head mounted display (HMD), or the like. The wearable device 2 may be a non-contact device capable of notifying a direction using an ultrasonic wave or the like without coming into contact with the skin of the user. The wearable device 2 is not a simple vibration device, and may be a device that can make the user feel a traction force.

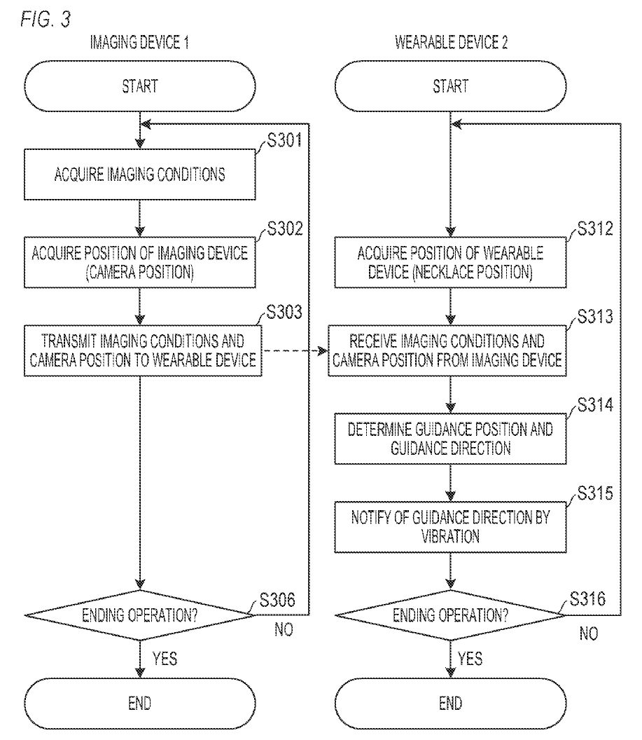

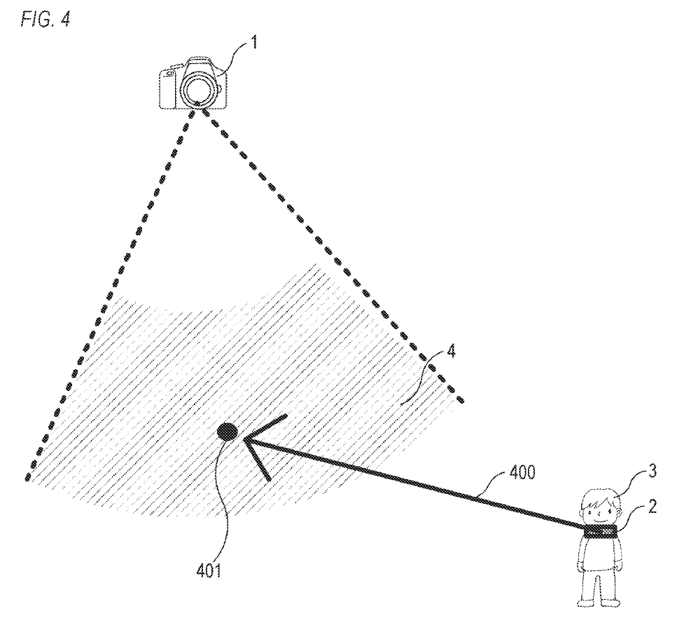

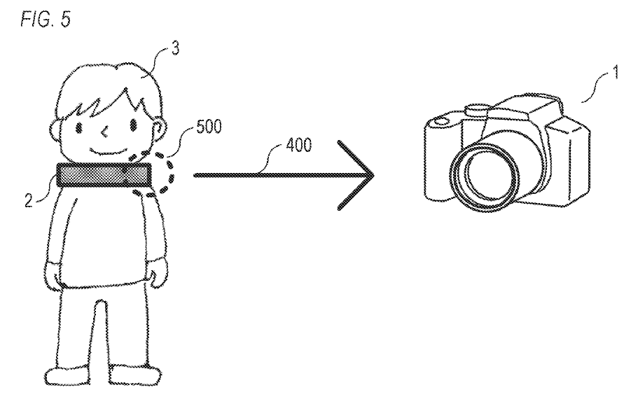

FIG. 3 is a flowchart illustrating an operation example of the imaging system according to the first embodiment. FIG. 4 is a schematic diagram illustrating an operation example of the imaging system according to the first embodiment.

An operation of the imaging device 1 starts in response to a user operation on the operation unit 108 of the imaging device 1.

In S301 of FIG. 3, the control unit 101 of the imaging device 1 acquires imaging conditions indicating an imaging view angle, a focus range, an imaging state, and the like, and stores the imaging conditions in the primary storage unit 104.

In S302, the control unit 101 uses the position acquisition unit 110 to acquire a camera position (X1, Y1, Z1) that is a current position of the imaging device 1, and stores the camera position in the primary storage unit 104.

In S303, the control unit 101 transmits the imaging conditions and the camera position (X1, Y1, Z1) stored in the primary storage unit 104 to the wearable device 2 using the communication unit 103.

In S306, the control unit 101 determines whether an ending operation that is a user operation of ending an operation of the imaging device 1 has been performed on the operation unit 108. When the ending operation has been performed, the operation of the imaging device 1 ends. Otherwise, the process proceeds to S301.

Similarly to the imaging device 1, the operation of the wearable device 2 starts in response to the user operation on the operation unit 208 of the wearable device 2.

In S312, the control unit 201 of the wearable device 2 uses the position acquisition unit 210 to acquire a necklace position (X2, Y2, Z2) that is a current position of the wearable device 2, and stores the necklace position in the primary storage unit 204.

In S313, the control unit 201 receives the imaging conditions and the camera position (X1, Y1, Z1) from the imaging device 1 using the communication unit 203, and stores the imaging conditions and the camera position in the primary storage unit 204.

In S314, the control unit 201 determines a guidance position that is a position within the imaging range of the imaging device 1, using the information processing unit 202, and determines a guidance direction that is a direction from the wearable device 2 to the guidance position. The control unit 201 determines an imaging range 4 of the imaging device 1 illustrated in FIG. 4 based on the imaging condition and the camera position (X1, Y1, Z1) stored in the primary storage unit 204, and determines the barycenter 401(a barycentric position (X3, Y3, Z3)) of the imaging range 4 as the guidance position. In FIG. 4, the imaging range 4 is assumed to be a focus range, but the imaging range 4 may be the entire range to be imaged or a part of a range to be imaged. The imaging range 4 may be narrower or wider than the focus range. The control unit 201 stores the imaging range 4 and the barycenter 401 (the barycentric position (X3, Y3, Z3)) in the primary storage unit 204. Then, the control unit 201 determines a guidance direction 400 from the wearable device 2 (object 3) to the barycenter 401 based on the necklace position (X2, Y2, Z2) and the barycentric position (X3, Y3, Z3) stored in the primary storage unit 204. The control unit 201 also stores the guidance direction 400 in the primary storage unit 204. The object 3 is a user of the wearable device 2.

When the necklace position (X2, Y2, Z2) matches the barycentric position (X3, Y3, Z3), the control unit 201 stores information indicating that there is no guidance direction 400 in the primary storage unit 204 so that notification of the guidance direction 400 is not given (as described below). Even when the imaging device 1 is on imaging standby (not imaging), information indicating that there is no guidance direction 400 may be stored in the primary storage unit 204.

In S315, the control unit 201 notifies the object 3 wearing the wearable device 2 of the guidance direction 400 stored in the primary storage unit 204 using the vibration unit 209. FIG. 5 is a schematic diagram illustrating an operation example of the wearable device 2 in S315. The vibration unit 209 notifies the object 3 of the guidance direction 400 by vibrating a portion 500 corresponding to the guidance direction 400. For example, when the object 3 (the wearable device 2) reaches the guidance position, the notification is stopped.

The vibration unit 209 may change a vibration pattern (for example, a vibration intensity or a vibration cycle) of the wearable device 2 in accordance with a distance from the wearable device 2 to the guidance position. For example, the vibration unit 209 may vibrate the wearable device 2 with a stronger vibration intensity or a shorter vibration cycle as the wearable device 2 is closer to the guidance position. In this way, the object 3 can ascertain a sense of distance as to whether the object 3 is close to or far from the guidance position. The control unit 201 may notify the distance from the wearable device 2 to the guidance position by a notification method different from the vibration of the wearable device 2. For example, when the wearable device 2 includes a temperature generation unit, the control unit 201 may change a temperature of the wearable device 2 according to the distance from the wearable device 2 to the guidance position using the temperature generation unit.

In S316, the control unit 201 determines whether an ending operation that is a user operation of ending the operation of the wearable device 2 is performed on the operation unit 208. When the ending operation is performed, the operation of the wearable device 2 ends. Otherwise, the process proceeds to S312.

As described above, according to the first embodiment, the guidance position in the imaging range 4 is determined, the guidance direction 400 from the wearable device 2 to the guidance position is determined, and the object 3 is notified of the guidance direction 400 by the vibration of the wearable device 2. In this way, the object 3 can immediately enter the imaging range 4. The position of the imaging device 1, the position of the wearable device 2, and the imaging condition (such as the imaging range 4) change from moment to moment. However, since the guidance direction 400 is updated in real time, the portion 500 vibrated by the vibration unit 209 also changes from moment to moment. Accordingly, the object 3 can ascertain the guidance direction 400 (a direction toward the guidance position) in real time.

When the guidance direction 400 is notified of by sound, unintended sound may be included in a captured (recorded) moving image, or the object 3 may not be able to ascertain the notification of the guidance direction 400 due to noise. When the guidance direction 400 is notified of by an image, this causes unnatural movement of the line of sight of the object 3. In the first embodiment, since the guidance direction 400 is notified of by vibration, this problem does not occur.

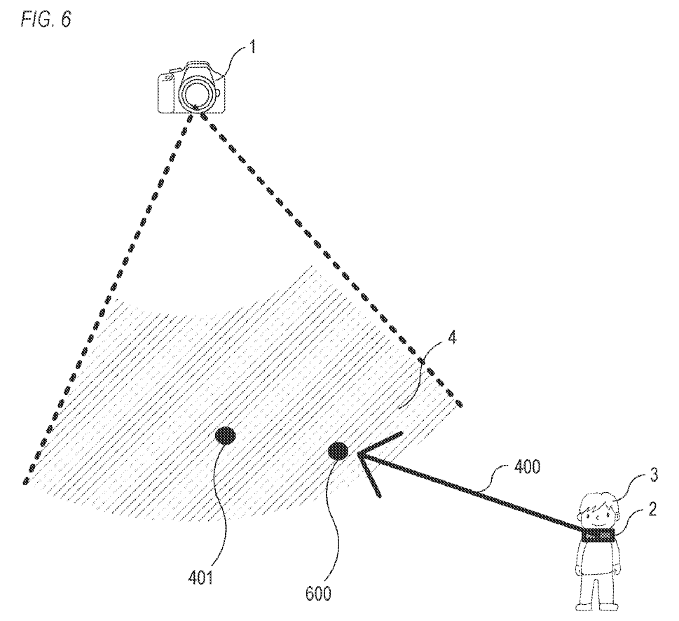

As illustrated in FIG. 6, a position 600 different from the barycenter 401 of the imaging range 4 may be determined as the guidance position. The guidance position may be determined based on a distance from the wearable device 2, an image captured by the imaging device 1, or the like. The position closest to the wearable device 2 in the imaging range 4 may be determined as the guidance position. A position (for example, an optimum position of the object 3 from the viewpoint of composition) based on the composition of an image captured by the imaging device 1 may be determined as the guidance position.

When the state of the object 3 is the predetermined state, the guidance direction 400 may not be notified of by the vibration of the wearable device 2. A method of detecting the state of the object 3 is not particularly limited. However, for example, the information processing unit 202 may detect a state of the object 3 based on a temporal change in a position of the wearable device 2 obtained by the position acquisition unit 210. The predetermined state is also not particularly limited. For example, the predetermined state is a state in which notification by vibration becomes troublesome for the object 3, and includes at least one of a state in which the object 3 moves with intensity greater than a predetermined threshold, a state in which the object 3 is sleeping, and a state in which the object 3 is talking.

The control unit 201 may select one or more of a plurality of notification methods including vibration of the wearable device 2 and notify the object 3 of the guidance direction 400 or the like by the selected notification method. When the state of the object 3 is the predetermined state, the control unit 201 may notify the object 3 of the guidance direction 400 by a notification method different from the vibration of the wearable device 2. The plurality of notification methods include, for example, at least one of an output of sound, display of an image, a change in temperature, and generation of odor.

The notification of the guidance direction 400 may be performed at the time of capturing a still image or at the time of capturing a moving image. The user of the imaging device 1 or the wearable device 2 may be able to set whether to notify of the guidance direction 400.

When a predetermined time has passed after the notification of the guidance direction 400 to the object 3 by the vibration of the wearable device 2 without the object 3 approaching the guidance position (without moving), there is a high possibility of the object 3 not becoming aware of the notification. Therefore, in that case, the control unit 201 may notify the object 3 of the guidance direction 400 by a notification method different from the vibration of the wearable device 2.

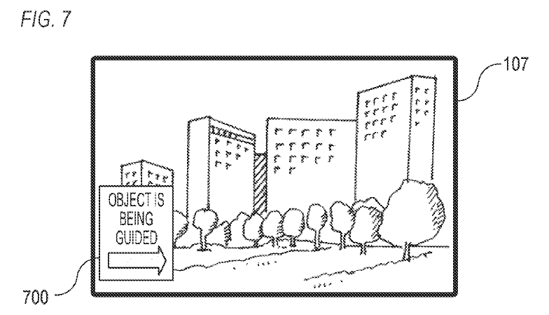

The notification of the guidance direction 400 may be given when the user of the imaging device 1 and the user of the wearable device 2 perform the same selfie imaging, or may be performed when the user of the imaging device 1 and the user of the wearable device 2 perform different non-selfie imaging. In the case of the non-selfie imaging, when a user (photographer) of the imaging device 1 pays attention to a live view image on the display unit 107, the user cannot ascertain from which direction the object 3 is guided to enter the angle of view. Therefore, as illustrated in FIG. 7, the control unit 101 may display an item 700 indicating the guidance direction 400 on the display unit 107 during the notification of the guidance direction 400. The item 700 may include text or an object. The control unit 101 may notify the photographer of the guidance direction 400 by a notification method (for example, sound) different from the display of the item 700.

At least one of the plurality of processes (a plurality of types of control) described as being performed by the wearable device 2 may be performed by the imaging device 1 or may be performed by another external device such as a cloud server. Similarly, at least one of the plurality of processes (a plurality of types of control) described as being performed by the imaging device 1 may be performed by the wearable device 2 or may be performed by another external device such as a cloud server. For example, the wearable device 2 may transmit necessary information to the imaging device 1, and the information processing unit 102 of the imaging device 1 may determine the guidance direction 400.

### Second Embodiment

A second embodiment of the present disclosure will be described. In the following description, configurations and processes similar to those of the first embodiment will not be described, and configurations and processes different from those of the first embodiment will be described.

In the first embodiment, as described, the imaging system includes one wearable device. In the second embodiment, it is assumed that the imaging system includes a plurality of wearable devices. It is difficult to arrange a plurality of wearable devices (a plurality of objects) at the same position. Therefore, in the second embodiment, a plurality of different guidance positions are determined, and a plurality of objects wearing a plurality of wearable devices are notified of a plurality of guidance directions having different guidance positions, respectively.

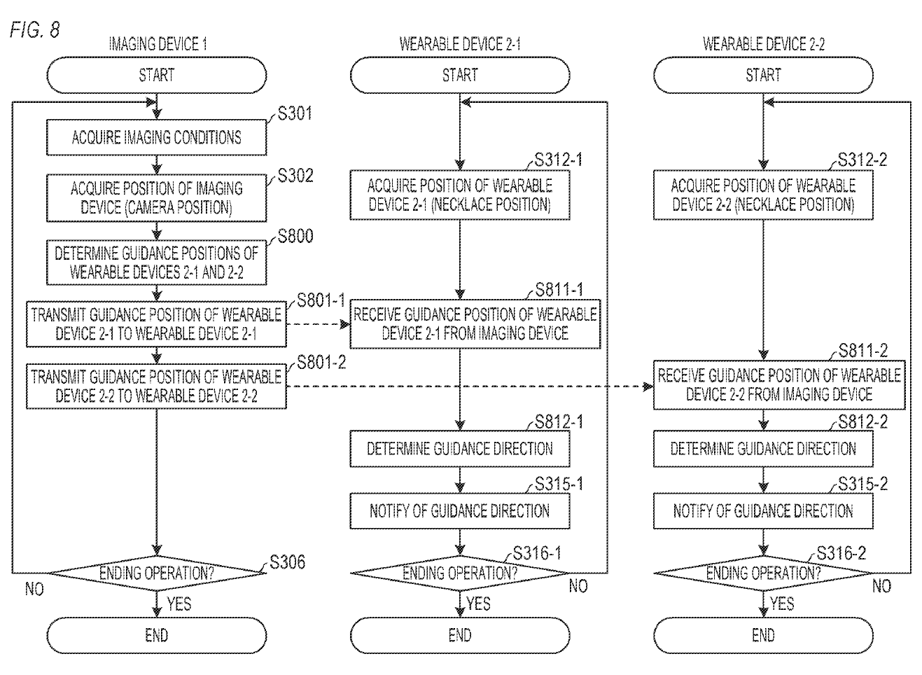

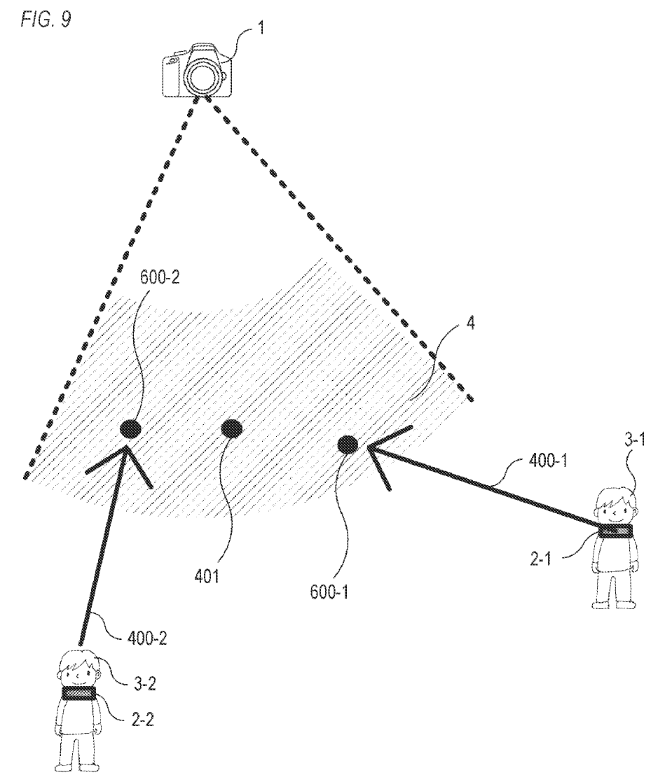

FIG. 8 is a flowchart illustrating an operation example of an imaging system according to a second embodiment. FIG. 9 is a schematic diagram illustrating an operation example of the imaging system according to the second embodiment. The wearable devices 2-1 and 2-2 have the same configuration as the wearable device 2 of the first embodiment. In order to distinguish the constituents of the wearable device 2-1 from the constituents of the wearable device 2-2, the constituents of the wearable device 2-1 are denoted by reference numerals having a suffix of “-1”, and the constituents of the wearable device 2-2 are denoted by reference numerals having a suffix of “-2”.

In an operation of the imaging device 1 illustrated in FIG. 8, similarly to the first embodiment (FIG. 3), the control unit 101 acquires imaging conditions in S301 and stores the imaging conditions in the primary storage unit 104.

Similarly to the first embodiment (FIG. 3), the control unit 101 uses the position acquisition unit 110 to acquire a camera position that is a current position of the imaging device 1 in S302, and stores the camera position in the primary storage unit 104.

In S800, the control unit 101 determines a guidance position of the wearable device 2-1 and a guidance position of the wearable device 2-2 using the information processing unit 102. The guidance position of the wearable device 2-1 may be interpreted as the guidance position of the object 3-1 on which the wearable device 2-1 is worn, and the guidance position of the wearable device 2-2 may be interpreted as the guidance position of the object 3-2 on which the wearable device 2-2 is worn. The control unit 101 determines the imaging range 4 of the imaging device 1 illustrated in FIG. 9 based on the imaging conditions and the camera position stored in the primary storage unit 104. The position 401 is the barycenter (a barycentric position (X3, Y3, Z3)) of the imaging range 4. Then, the control unit 101 determines a position 600-1 in the imaging range 4 as a guidance position of the wearable device 2-1, and determines a position 600-2 in the imaging range 4 as a guidance position of the wearable device 2-2. The control unit 101 stores the imaging range 4, the barycenter 401, the position 600-1, the position 600-2, and the like in the primary storage unit 104.

As long as the guidance position 600-1 and the guidance position 600-2 are different, the method of determining the guidance position 600-1 and the guidance position 600-2 is not particularly limited. For example, the guidance positions 600-1 and 600-2 may be determined such that a distance from the imaging device 1 to the guidance position 600-1 is equal to a distance from the imaging device 1 to the guidance position 600-2. An optimum position of object 3-1 and an optimum position of object 3-2 from the viewpoint of composition may be determined as the guidance positions 600-1 and 600-2.

In S801-1, the control unit 101 transmits the guidance position 600-1 of the wearable device 2-1 stored in the primary storage unit 104 to the wearable device 2-1 using the communication unit 103.

In S801-2, the control unit 101 transmits the guidance position 600-2 of the wearable device 2-2 stored in the primary storage unit 104 to the wearable device 2-2 using the communication unit 103.

Similarly to the first embodiment (FIG. 3), in S306, the control unit 101 determines whether an ending operation that is a user operation of ending the operation of the imaging device 1 has been performed on the operation unit 108. When the ending operation has been performed, the operation of the imaging device 1 ends. Otherwise, the process proceeds to S301.

In the operation of the wearable device 2-1 illustrated in FIG. 8, similarly to S312 of the first embodiment (FIG. 3), in S312-1, the control unit 201-1 acquires a necklace position A that is a current position of the wearable device 2-1, using the position acquisition unit 210-1. Then, the control unit 201-1 stores the necklace position A in the primary storage unit 204-1.

In S811-1, the wearable device 2-1 receives the guidance position 600-1 from the imaging device 1 using the communication unit 203-1, and stores the guidance position 600-1 in the primary storage unit 204-1.

In S812-1, the control unit 201-1 determines a guidance direction 400-1 from the wearable device 2-1 (object 3-1) to the guidance position 600-1 using an information processing unit 202-1. The guidance direction 400-1 is determined based on the guidance position 600-1 and the necklace position A stored in the primary storage unit 204-1. The control unit 201-1 stores the guidance direction 400-1 in the primary storage unit 204-1.

Similarly to S315 of the first embodiment (FIG. 3), in S315-1, the control unit 201-1 notifies the object 3-1 wearing the wearable device 2-1 of the guidance direction 400-1 stored in the primary storage unit 204-1 using a vibration unit 209-1.

Similarly to S316 of the first embodiment (FIG. 3), in S316-1, the control unit 201-1 determines whether the ending operation that is a user operation of ending the operation of the wearable device 2-1 is performed on the operation unit 208-1. When the ending operation is performed, the operation of the wearable device 2-1 ends. Otherwise, the process proceeds to S312-1.

An operation of the wearable device 2-2 illustrated in FIG. 8 is similar to the operation of the wearable device 2-1.

In S312-2, the control unit 201-2 acquires a necklace position B that is a current position of the wearable device 2-2, using the position acquisition unit 210-2. Then, the control unit 201-2 stores the necklace position B in the primary storage unit 204-2.

In S811-2, the wearable device 2-2 receives the guidance position 600-2 from the imaging device 1 using the communication unit 203-2, and stores the guidance position in the primary storage unit 204-2.

In S812-2, the control unit 201-2 determines a guidance direction 400-2 from the wearable device 2-2 (object 3-2) to the guidance position 600-2 using an information processing unit 202-2. The guidance direction 400-2 is determined based on the guidance position 600-2 and the necklace position B stored in the primary storage unit 204-2. The control unit 201-2 stores the guidance direction 400-2 in the primary storage unit 204-2.

In S315-2, the control unit 201-2 notifies the object 3-2 wearing the wearable device 2-2 of the guidance direction 400-2 stored in the primary storage unit 204-2 using the vibration unit 209-2.

In S316-2, the control unit 201-2 determines whether an ending operation that is a user operation of ending the operation of the wearable device 2-2 is performed on the operation unit 208-2. When the ending operation is performed, the operation of the wearable device 2-2 ends. Otherwise, the process proceeds to S312-2.

As described above, according to the second embodiment, a plurality of objects each wearing a plurality of wearable devices are notified of a plurality of guidance directions having different guidance positions, respectively. In this way, each of the plurality of objects can be guided to a suitable position without guiding the plurality of objects to the same position. Although the example in which two wearable devices are used has been described, three or more wearable devices may be used.

### Third Embodiment

A third embodiment of the present disclosure will be described. In the following description, configurations and processes similar to those of the first embodiment will not be described, and configurations and processes different from those of the first embodiment will be described.

A third embodiment will be described. In the first embodiment, the position within the imaging range of the imaging device is determined as the guidance position. In the third embodiment, a position outside of the imaging range may be determined as a guidance position based on the imaging range. Then, it is assumed that the imaging range is changed such that a specific position in the imaging range substantially matches the guidance position.

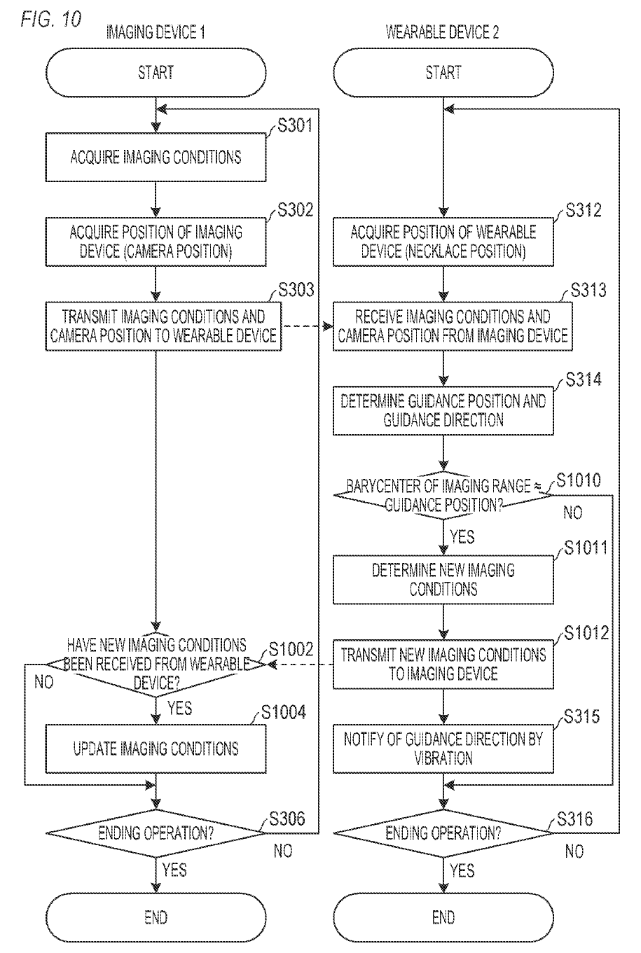

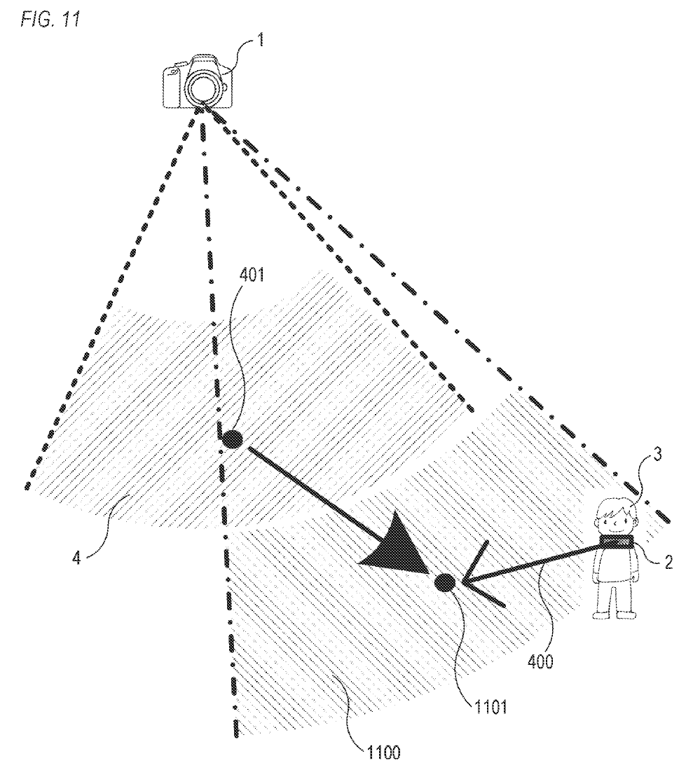

FIG. 10 is a flowchart illustrating an operation example of an imaging system according to a third embodiment. FIG. 11 is a schematic diagram illustrating an operation example of the imaging system according to the third embodiment.

In the operation of the wearable device 2 illustrated in FIG. 10, similarly to the first embodiment (FIG. 3), in S312, the control unit 201 uses the position acquisition unit 210 to acquire a necklace position that is a current position of the wearable device 2, and stores the necklace position in the primary storage unit 204.

Similarly to the first embodiment (FIG. 3), in S313, the control unit 201 receives the imaging conditions and the camera position from the imaging device 1 using the communication unit 203, and stores the imaging conditions and the camera position in the primary storage unit 204.

As in the first embodiment (FIG. 3), in S314, the control unit 201 determines a guidance position 1101 and a guidance direction 400 illustrated in FIG. 11 using the information processing unit 202, and stores them in the primary storage unit 204. In the first embodiment, as described, a position within the imaging range is determined as the guidance position. In the third embodiment, the guidance position 1101 is determined based on the imaging range 4 such that the distance from a specific position in the imaging range 4 to the guidance position 1101 is shorter than the distance from the specific position to the necklace position. For example, an intermediate position between the necklace position and a specific position in the imaging range 4 is determined as the guidance position 1101. Therefore, a position within the imaging range 4 may be determined as the guidance position 1101, and a position outside of the imaging range 4 may be determined as the guidance position 1101. The specific position is a position within the imaging range 4 and is, for example, the barycenter 401 of the imaging range 4.

In S1010, the control unit 201 uses the information processing unit 202 to determine whether the barycenter 401 (specific position) of the imaging range 4 substantially matches the guidance position 1101. “Substantially matching” may include “exactly matching”. When the barycenter 401 substantially matches the guidance position 1101, the process proceeds to S315. Otherwise (when the barycenter 401 does not substantially match the guidance position 1101), the process proceeds to S1011.

In S1011, the control unit 201 uses the information processing unit 202 to determine new imaging conditions for changing the imaging range 4 so that the barycenter 401 substantially matches the guidance position 1101, and stores the new imaging conditions in the primary storage unit 204.

In S1012, the control unit 201 transmits the new imaging conditions stored in the primary storage unit 204 to the imaging device 1 using the communication unit 203.

As in the first embodiment (FIG. 3), in S315, the control unit 201 notifies the object 3 wearing the wearable device 2 of the guidance direction 400 stored in the primary storage unit 204 using the vibration unit 209.

Similarly to the first embodiment (FIG. 3), in S316, the control unit 201 determines whether the ending operation that is a user operation of ending the operation of the wearable device 2 is performed on the operation unit 208. When the ending operation is performed, the operation of the wearable device 2 ends. Otherwise, the process proceeds to S312.

In the operation of the imaging device 1 illustrated in FIG. 10, similarly to the first embodiment (FIG. 3), in S301, the control unit 101 acquires the imaging conditions and stores the imaging conditions in the primary storage unit 104.

Similarly to the first embodiment (FIG. 3), the control unit 101 uses the position acquisition unit 110 to acquire a camera position that is a current position of the imaging device 1 in S302, and stores the camera position in the primary storage unit 104.

Similarly to the first embodiment (FIG. 3), in S303, the control unit 101 transmits the imaging conditions and the camera position stored in the primary storage unit 104 to the wearable device 2 using the communication unit 103.

In S1002, the control unit 101 determines whether the new imaging conditions have been received from the wearable device 2 using the communication unit 103. When the new imaging conditions have been received (the new imaging condition is stored in the primary storage unit 104), the process proceeds to S1004. Otherwise, the process proceeds to S306.

In S1004, the control unit 101 updates the imaging conditions set in the imaging device 1 to the new imaging conditions received in S1002. Accordingly, the imaging range is changed (updated) from the imaging range 4 to an imaging range 1100, and the barycenter of the imaging range substantially matches the guidance position 1101.

As described above, according to the third embodiment, since the imaging range is changed such that a specific position in the imaging range substantially matches the guidance position, the moving distance of the object to the guidance position can be shortened. As a result, the object 3 can enter the imaging range 4 in a shorter time.

Priority may be set as to whether the current imaging range is prioritized or the current object position (necklace position) is prioritized. When the current imaging range is prioritized, a position closer to a specific position within the imaging range is determined as the guidance position so that an amount of change in the imaging range is reduced. A specific position may be determined as the guidance position so that the current imaging range is maintained. When the current object position is prioritized, a position closer to the current object position is determined as the guidance position so that an amount of movement of the object is reduced. The current object position may be determined as the guidance position so that the current object position is maintained.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, an imaging target user can immediately enter an imaging range of an imaging device.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-181286, filed October 16, 2024, which is hereby incorporated by reference herein in its entirety.

What is claimed is:

1. An imaging system comprising:
an imaging device; and
a wearable device,
wherein the imaging device or the wearable device is configured to perform a first determination process of determining a guidance position that is a position within an imaging range of the imaging device,
wherein the imaging device or the wearable device is configured to perform a second determination process of determining a guidance direction that is a direction from the wearable device to the guidance position, and
wherein the imaging device or the wearable device is configured to perform a control process of performing control such that a user wearing the wearable device is notified of the guidance direction by vibration of the wearable device.

2. The imaging system according to claim 1, wherein the guidance position is
a barycentric position of the imaging range,
a position closest to the wearable device in the imaging range, or
a position that is based on a composition of an image captured by the imaging device.

3. The imaging system according to claim 1,
wherein, in the control process, control is performed such that a vibration pattern of the wearable device is changed in accordance with a distance from the wearable device to the guidance position.

4. The imaging system according to claim 1,
wherein the imaging device or the wearable device is configured to perform a detection process of detecting a state of the user, and
wherein, in a case where the state of the user is a predetermined state, in the control process, control is performed such that the user is not notified of the guidance direction by vibration of the wearable device.

5. The imaging system according to claim 4,
wherein the predetermined state includes at least one of a state in which the user is moving with intensity greater than a predetermined threshold, a state in which the user is sleeping, and a state in which the user is talking.

6. The imaging system according to claim 1,
wherein, in the control process, control is performed such that one or more of a plurality of notification methods including vibration of the wearable device is selected and the user is notified of the guidance direction by the selected notification method.

7. The imaging system according to claim 6,
wherein the plurality of notification methods include at least one of output of a sound, display of an image, a change in temperature, and generation of an odor.

8. The imaging system according to claim 6,
wherein, in a case where a predetermined time has passed after the notification of the guidance direction to the user by the vibration of the wearable device without the user approaching the guidance position, in the control process, control is performed such that the user is notified of the guidance direction by a notification method different from the vibration of the wearable device.

9. The imaging system according to claim 1,
wherein the imaging device or the wearable device is configured to perform a display control process of performing control such that an item indicating the guidance direction is displayed on a display of the imaging device during notification of the guidance direction.

10. The imaging system according to claim 1,
wherein the imaging system comprises the imaging device and a plurality of wearable devices, and
wherein a plurality of users wearing the plurality of wearable devices are notified of a plurality of guidance directions corresponding to different guidance positions.

11. The imaging system according to claim 1,
wherein, in the first determination process, the guidance position is determined on a basis of the imaging range, and
wherein the imaging device or the wearable device is configured to perform a changing process of changing the imaging range such that a specific position in the imaging range substantially matches the guidance position.

12. The imaging system according to claim 1,
wherein, in the first determination process, a position within the imaging range is determined as the guidance position.

13. The imaging system according to claim 1,
wherein the imaging range is a focus range.

14. The imaging system according to claim 1,
wherein, in a case where the imaging device is not capturing an image, in the control process, control is performed such that the user is not notified of the guidance direction.

15. An imaging device in an imaging system including the imaging device and a wearable device,
wherein the imaging device or the wearable device is configured to perform a first determination process of determining a guidance position that is a position within an imaging range of the imaging device,
wherein the imaging device or the wearable device is configured to perform a second determination process of determining a guidance direction that is a direction from the wearable device to the guidance position, and
wherein the imaging device is configured to perform a control process of performing control such that a user wearing the wearable device is notified of the guidance direction by vibration of the wearable device.

16. A wearable device in an imaging system including an imaging device and the wearable device,
wherein the imaging device or the wearable device is configured to perform a first determination process of determining a guidance position that is a position within an imaging range of the imaging device,
wherein the imaging device or the wearable device is configured to perform a second determination process of determining a guidance direction that is a direction from the wearable device to the guidance position, and
wherein the wearable device is configured to perform a notification process of notifying the guidance direction to a user wearing the wearable device by vibration of the wearable device.

17. A control method of an imaging system including an imaging device and a wearable device, the control method comprising:
determining a guidance position that is a position within an imaging range of the imaging device;
determining a guidance direction that is a direction from the wearable device to the guidance position; and
performing control such that a user wearing the wearable device is notified of the guidance direction by vibration of the wearable device.

18. A non-transitory computer readable medium that stores a program, wherein the program causes a computer to execute a control method of an imaging system including an imaging device and a wearable device, the control method comprising:
determining a guidance position that is a position within an imaging range of the imaging device;
determining a guidance direction that is a direction from the wearable device to the guidance position; and
performing control such that a user wearing the wearable device is notified of the guidance direction by vibration of the wearable device.
